(19) United States
(12) Patent Application Publication
(10) Pub. No.: US 2006/0196371 A1
(43) Pub. Date: Sep. 7, 2006

(54) Portable credit card imprinter

(76) Inventor: Sotirios Stefanos Naoumis, Karditsa (GR)

Correspondence Address: LADAS & PARRY, 26 WEST 61ST STREET, NEW YORK, NY, 10023, US

(21) Appl. No.: 11/069,853

(22) Filed: Mar. 1, 2005

(51) Int. Cl. B41F 19/02

(52) U.S. Cl. 101/22

(57) ABSTRACT

The invention is a portable credit card imprinter, which has the potential to imprint, by applying pressure, upon a formset, the embossed characters of a credit card and a merchant plate.

The invention consists of a one-piece small base plate (1), made of an extruded piece of aluminum, having along the length of its sidewalls two formed grooves—edges (3, 4). Within the base's edges, an imprinting head (2), consisting of two independently adjusted rolling platens (21, 22) that change position alternatively based on a single and uniquely shaped axle (26), moves in a reciprocal motion. At the ends of the base's internal grooves—edges two plastic end walls (12, 13) are adjusted, causing the rotation of the rolling platens. The specific device is portable, robust and simple to function, providing excellent imprinting quality for long periods of time and permitting the user to control—adjust the quality of imprinting. The main use of the device is to imprint the embossed data of credit cards upon a formset.

The invention refers to a portable imprinting credit card device, which has the potential to imprint, by applying pressure, upon a document (e.g. transaction receipt) the embossed characters of a credit card and a merchant plate.

The imprinting credit card devices are devices that are found in a variety of retail establishments, which deal in the field of credit buying. The particular apparatuses imprint the embossed alphanumeric characters on a credit card and the vendor's information on a merchant plate, by applying pressure upon a joined pile of forms (i.e. triple form).

The imprinting credit card devices usually consist of a rectangular base plate and a moving carriage said imprinting head, which is manually pulled back-and-forth along the length of the base plate. The imprinting head comprises one cylinder said rolling platen mounted on one axle or two cylinders said rolling platens, each mounted on two separate axles and is adjusted upon the base with the use of a specially designed sliding ledge. The most common dimension of such a device is approximately 300×140×70 mm (length×width×height).

The merchant plate is adjusted permanently onto the base plate and a set of guide fingers is positioned for the credit card and the form set.

Once the formset said sales slip is placed within the set of guide fingers, with a hand operated back and forth movement of the imprinting head over the base plate, the rolling platens press the form set against the credit card and the merchant plate. As a result the credit card's as well as the merchant plate's embossed characters are printed onto the form set.

The merchant plate generally is a rectangular plate and usually having raised embossed characters provides the account number, name, address and in some cases the official sign or symbol of the retail establishment that is making the sale.

The credit card having embossed characters provides information concerning the owner of the card. Such information is the card number, name and address of the purchaser as well as the expiry date of the card and the official sign or symbol of the credit card company.

The formset, which is used, consists of a number of pre-printed paper having blank spaces and with carbon paper in-between the copies. The purpose is to imprint upon the joined form sets' blank spaces the credit card's and merchant plate's correct data, which in continuation the credit card company will properly use in order to complete the transaction. The transaction amount is also written usually on the sales slip by pen as well as the signature of the credit card's owner.

Usually the credit card imprinting devices are quite rigid constructions in order to be able to imprint properly the sales slip with the embossed data from the card and the plate the moment the print pressure is applied. For this reason the credit card imprinters are quite bulky and heavy.

The credit card imprinting devices comprise a carriage, which includes one or two rolling platens. In cases where only one rolling platen is used, then with only one sole movement along the base plate the embossed data of both the card and the plate are imprinted upon the sales slip, with this one movement. In other words there is only one printing cycle. A drawback related to such an imprinter appears when the raised letters of a credit card differ in height, even slightly from those of the merchant plate. In such a case the imprinting of data, resulting either from the card or the plate will not be one of high quality. The above problem can be dealt with the adjustment of two different rolling platens, which respectively in one direction will imprint the data of the merchant plate and in the opposite direction those of the credit card, upon the sales slip.

Regarding devices that use two rolling platens, each time that the imprinting head changes direction, the rolling platens change respectively. When the imprinting head is pulled over the formset in one direction (usually right) the first rolling platen imprints. At the end of this travel across the base plate, with the help of a special stop (end), which is located at the end of the base, the specific rolling platen is urged upwards and the other rolling platen is shifted from the upward position to a downward print position. This occurs while the imprinting head is changing direction (traveling left) to return to the starting position. Once the imprinting head has reached the starting point, a second stop (end) forces the rolling platen to change again positions. Thus the latter rolling platen is shifted again upwards and the former downwards. The above procedure guarantees excellent quality in imprinting, even in cases where the card and the plate differ in thickness.

For some devices however the users themselves are in position to adjust the distance between each rolling platen and the base plate with the use of small screws, which exert pressure on the rolling platen's axles. By this way the users can control easily the dark quality of the imprinting, according to the thickness of the form set used.

The foregoing devices are appropriate for use only in indoor stores, restaurants, e.t.c. They are usually placed on desks next to the counter. Their bulky size makes them inappropriate to be used as portable devices. As a result the sales person always has to take the customer's credit card with him and go to the desk where the imprinter is placed, imprint a form set and return to the customer with the imprinted form. In a large restaurant or department store, this procedure may cause a considerable delay, resulting in wasting the time of both the sales personnel and the customer's. Likewise a heavy and bulky apparatus is also difficult to be carried and be used by a taxi driver or street vendor.

A solution regarding the above problem relies on manufacturing a device which will be sufficiently light and portable so that it may be carried, at any time or place, by a waiter, a employee of a store or even a taxi driver. In addition, the imprinting can be applied in presence of the customer.

The portable credit card imprinters manufactured nowadays to manage the demand related to the field of credit buying, have the following drawbacks:
1. They are manufactured by plastic materials, which present contortions at high temperatures (−10° C. or +40° C.). The base plate consists of more than one sections that are assembled with screws and do not have a stable surface on which the imprinting head can move on. Therefore after a short period of usage, due to the contortions of the plastic parts and their junctions, their imprinting quality is neither stable nor good, showing blanks at many parts of the form set. Such a device is then considered useless.
2. They do not provide two printing cycles. As a result when the card is thicker than the plate, the only raised letters that are imprinted are those of the card. The same happens when the plate is thicker than the card.
3. They do not offer the potential to control (adjust) the distance between the rolling platens and the base plate, resulting in incongruity and bad quality of imprinting, in cases where different types of sales slips, concerning thickness, are used.

In conclusion the portable devices that are manufactured today cannot function properly and for a long period of usage.

The new invention is a small credit card imprinting device (approximate dimensions 160×105×35 mm, length×width×height) with a base plate manufactured by aluminum, supporting the upward and downward shifting of the two cylinders respectively and the user's adjustment of the distance between the rolling platens and the base plate. The device is very rigid and provides high quality printing for prolonged periods of usage, irrespective the thickness of the card or the plate. At the same time, it is very easy to use and it is very robust to user's inappropriate treatment (accidentally dropped or damaged).

### BRIEF DESCRIPTION OF THE DRAWINGS

FIG. 1 illustrates a ground plan of an assembled portable credit card imprinting device, which imprints upon a form set the embossed data of a credit card and a merchant plate, according to the present invention.

FIG. 2 illustrates a cross-sectional view taken along section A-A of the assembled portable credit card imprinting device of FIG. 1.

FIG. 3 illustrates the ground plan of the one-piece integral aluminum base plate of the portable credit card imprinting device.

FIG. 4 illustrates a cross-sectional view taken along section A-A of the one-piece integral aluminum base plate of the portable credit card imprinting device of FIG. 3.

FIG. 5 illustrates the plastic end, which is adjusted at one end wall of the base plate and through which the form set is inserted.

FIG. 6 illustrates a ground plan of the plastic end of FIG. 5.

FIG. 7 illustrates the second plastic end, which is adjusted at the other end wall of the base plate.

FIG. 8 illustrates a ground plan of the second plastic end of FIG. 7

FIG. 9 illustrates a cross-sectional view taken along section A-A of the second plastic end of FIG. 7.

FIG. 10 illustrates a ground plan of the assembled imprinting head.

FIG. 11 illustrates a cross-sectional view taken along A-A of the assembled imprinting head of FIG. 10.

FIG. 12 illustrates a cross-sectional view taken along B-B of the assembled imprinting head of FIG. 10.

FIG. 13 illustrates a ground plan of the upper part of the imprinting head.

FIG. 14 illustrates a cross-sectional view taken along A-A of the upper part of the imprinting head.

FIG. 15 illustrates a ground plan of the lower part of the imprinting head.

FIG. 16 illustrates a cross sectional view taken along A-A of the lower part of the imprinting head.

FIG. 17 illustrates a special geometrical shaped axle on which the two rolling platens of the imprinting head are mounted.

FIG. 18 illustrates a ground plan of the special geometrical shaped axle of FIG. 17.

FIG. 19 illustrates a model of only one out of the four identical sliding parts.

FIG. 20 illustrates a cross sectional view taken along A-A of the sliding part of FIG. 19.

FIG. 21 illustrates a ground plan of the imprinting head's cover.

FIG. 22 illustrates a cross sectional view taken along A-A of the imprinting head's cover of FIG. 21.

FIG. 23 illustrates a cross sectional view taken along B-B of the imprinting head's cover of FIG. 21.

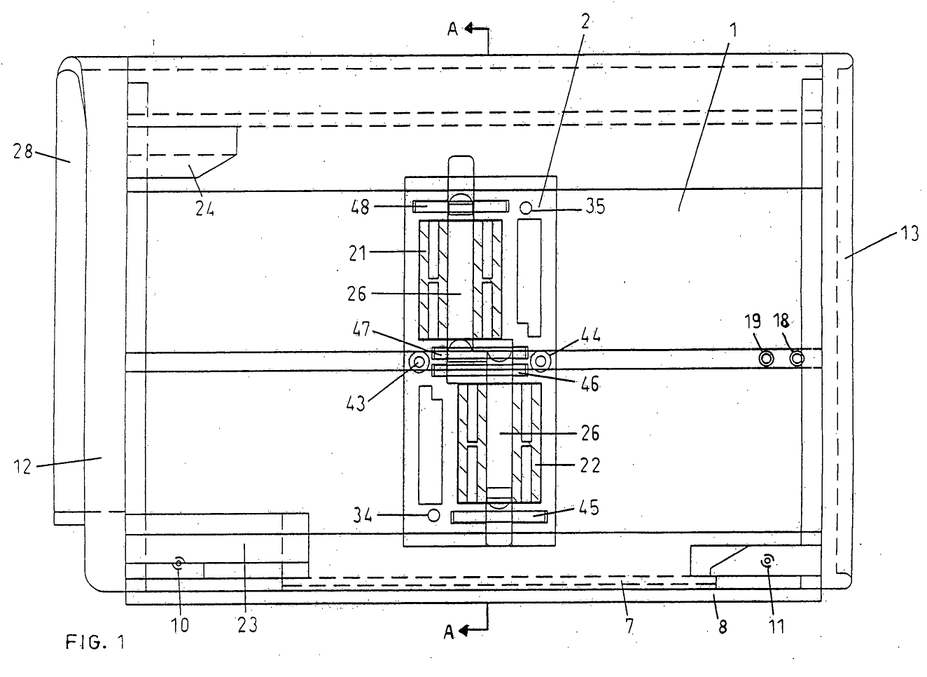

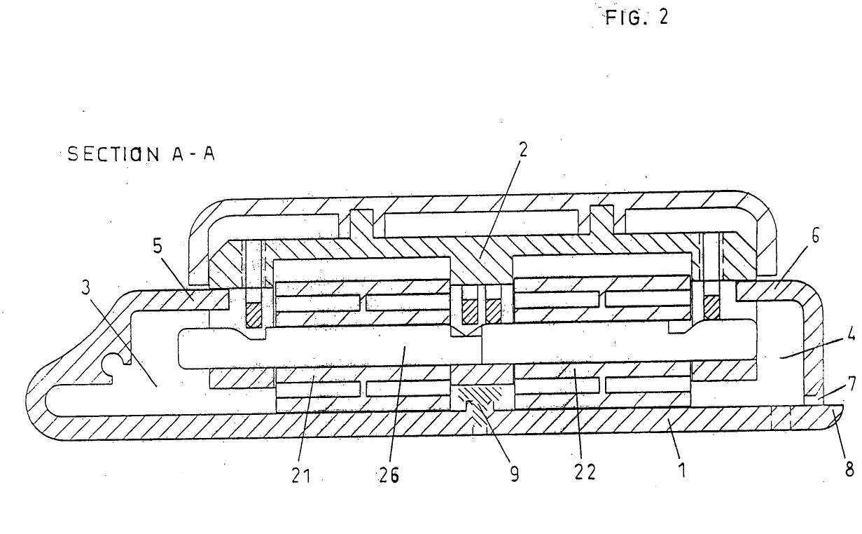

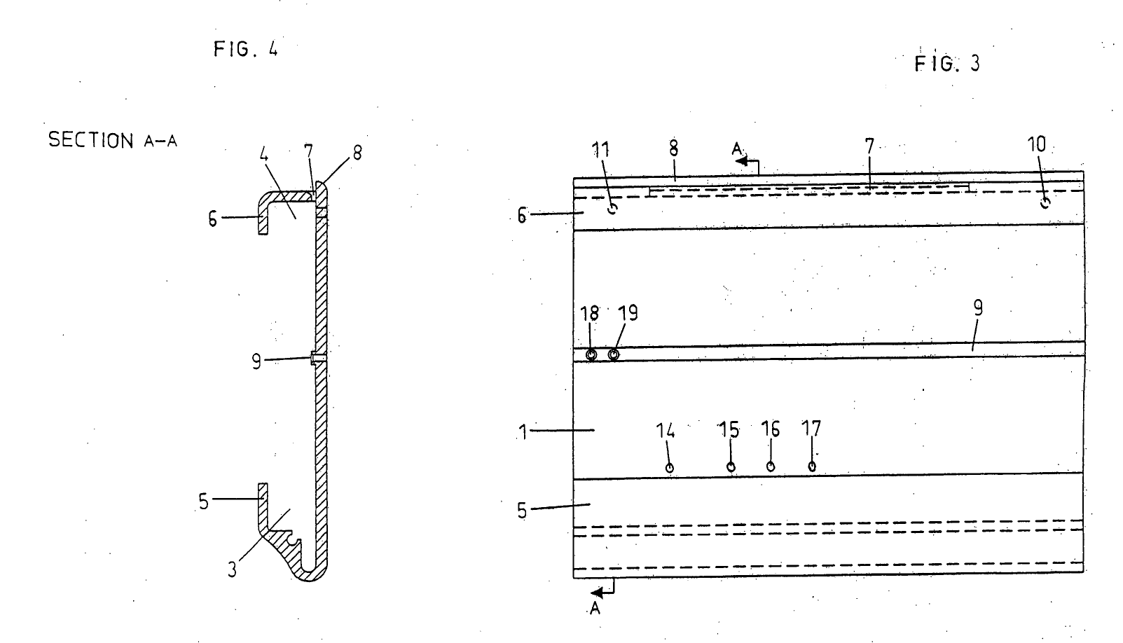

### DETAILED DESCRIPTION OF THE INVENTION'S SUGGESTED MODEL

This particular credit card imprinting device consists of a one piece small integral base plate (1), made of an extruded piece of aluminum and an imprinting head (2), made of thermosetting plastic material that is injection molded. The imprinting head travels in a reversible motion across the base plate.

The shape of the base plate (1) is rectangular, having its two larger ends forced upwards, forming an inverted Greek letter Π and bending (closing) slightly inwards, forming two grooves—edges (3, 4) along the length of the base's larger side walls and two flat surfaces (5, 6), upon which the imprinting head (2) slides in order to run over the base plate. At one side of the base there is a specially formed long but narrow cut (7), through which the insertion of the card can be accomplished. Along the length of the same side the aluminum is specially formed (8) in order to facilitate the insertion of the card. Along the top surface, maintaining its distance from the long—narrow cut (7), there is a specially formed projection (9), used to define the card's position (card receiving area) and to lead the form set to the correct position over the credit card and the merchant plate. At the two ends of only one of the base's side walls and indicated at the lower part of the base plate, there are two cuts (10, 11), at which the two plastic ends (12, 13) are assembled by screws. In addition, at the lower part of the base plate and within appropriate distances there are four cuts (14, 15, 16, 17), which are used for anchoring the merchant plate to the base plate. Finally, at the lower part of the base plate, but upon projection (9), there are two cuts (18, 19), used to support the small document's stop end (20).

At the ends of the base's internal grooves—edges two plastic end walls (12, 13) are adjusted. These are used as covers and as ending lines (stop lines) for the imprinting head's (2) reciprocal movement as well as the respective upwards and downwards shifting of the two rolling platens (21, 22).

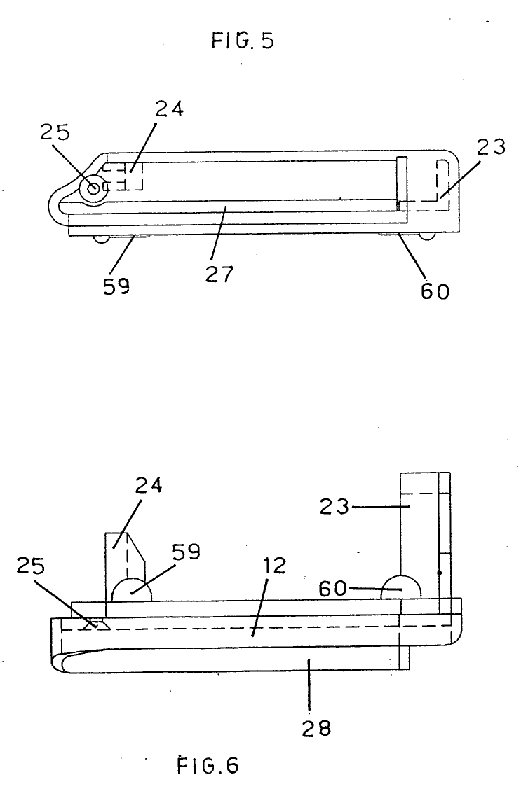

The plastic end (12), illustrated in FIGS. 5 and 6, has a special geometrical shape and four specially formed projections (23, 24, 59, 60). The first projection (23) is used to connect, with the use of screws, the end to the base plate (1), to lead the form set to the correct position during its insertion and finally to stabilize (hold) the card after its insertion. At the second projection (24) the rolling platens (21, 22) shift up and down respectively. The axle (26), being pressured by projection (24) during the ending of the imprinting head's (2) reciprocal motion, changes position towards the opposite direction causing the rolling platens to change position respectively. In other words, it causes now the first rolling platen to rise slightly and the second rolling platen to lower, ready to imprint. The third and fourth plastic projections (59, 60) are used for the adjustment of two round rubber bases to avoid the sliding of the credit card imprinting device. Along the end of the plastic end (12), there is a specially formed long—narrow cut (27), through which the form set is inserted upon the device as well as a special formation (28), which facilitates the insertion of the form set. The plastic end (12) is connected to the base with the use of a screw (25).

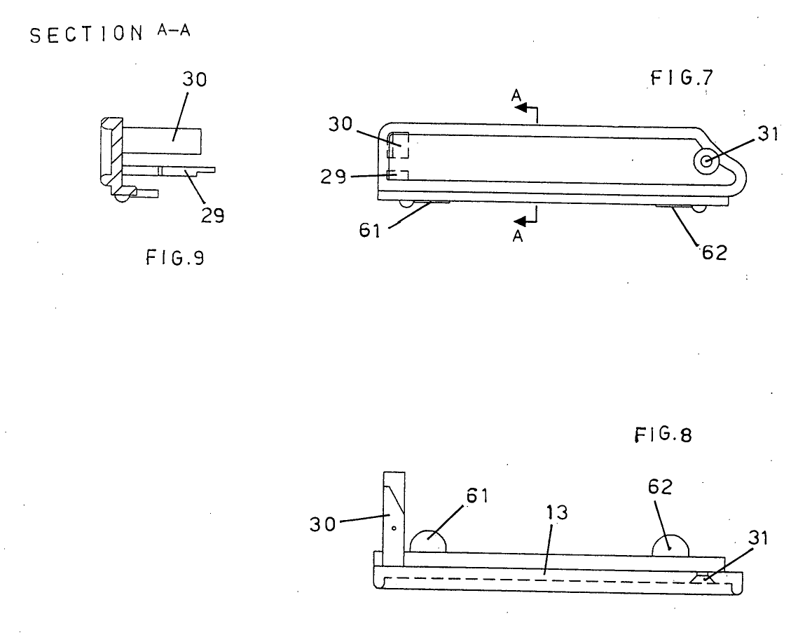

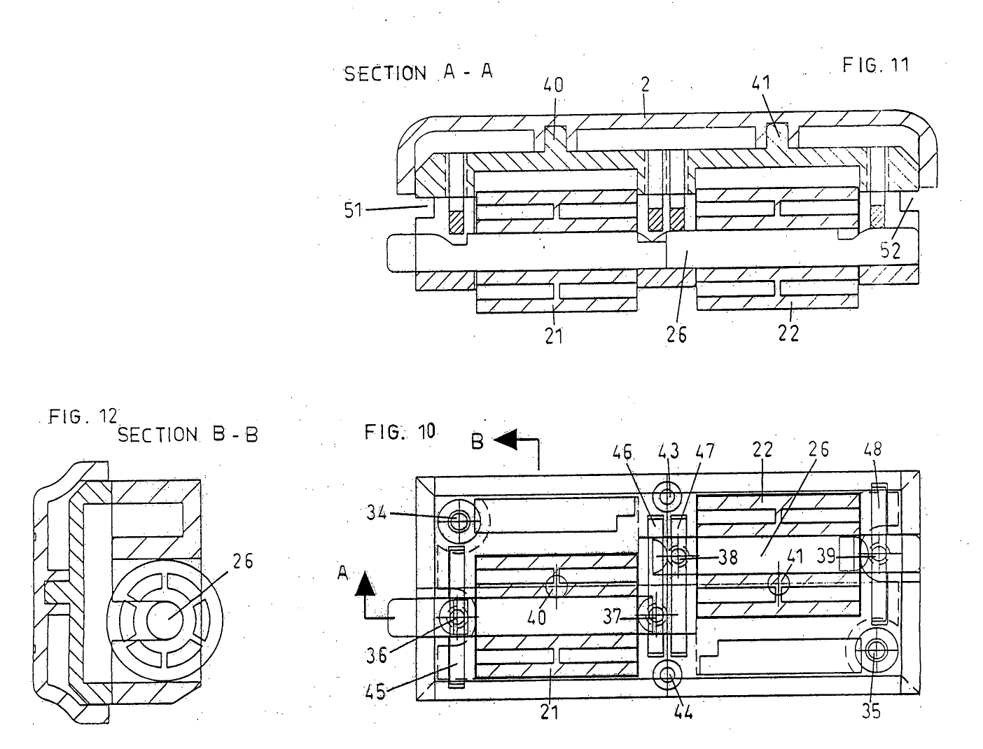

The plastic end (13), illustrated in FIGS. 7, 8 and 9, has a special geometrical shape and four specially formed projections (29, 30, 61, 62). The first projection (29) is used to connect, with the use of screws, the plastic end to the base plate (1) and to stabilize (hold) the card after its insertion. At the second projection (30) we have the shifting of the rotation of the rolling platens (21, 22) from their idle to their printing positions. The axle (26), being pressured by projection (30) during the ending of the imprinting head's (2) reciprocal motion, changes position towards the opposite direction causing the rolling platens to change position respectively. In other words it causes now the first rolling platen to rise slightly and the second rolling platen to lower, ready to imprint. Therefore while the imprinting head is returning to its starting position only one-rolling platen imprints. The third and fourth plastic projections (61, 62) are used for the adjustment of two round rubber bases to avoid the sliding of the credit card imprinting device. The plastic end (13) is connected to the base with the use of a screw (31).

Along the length of the base's two flat surfaces, slides the imprinting head (2), being at the same time perfectly fastened to the base. The imprinting head (2), consists of two special geometrical shape sections (32, 33) that are bound together by two screws (34, 35).

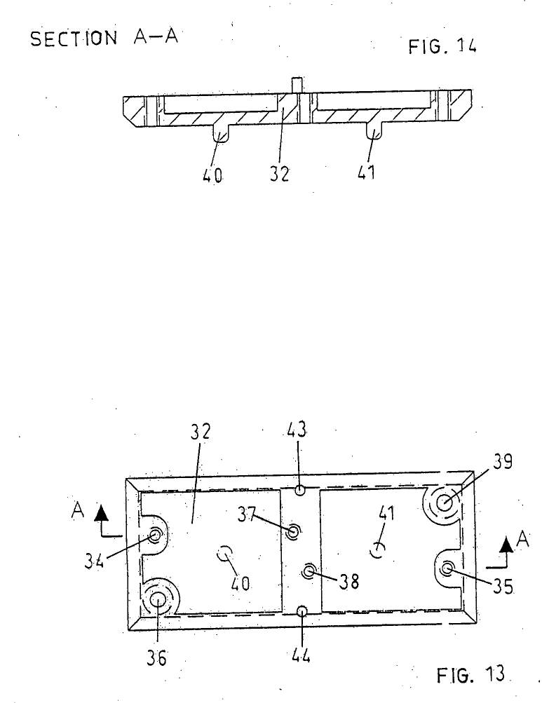

On the upper part of the imprinting head (32), as depicted in FIGS. 13 and 14, within specific locations, there are four shaped perforations (36, 37, 38, 39), upon which lean the four screws that control the distance between the rolling platens (21, 22) and the base plate (1). Also, there are two spigots (40, 41), upon which the plastic cover of the imprinting head (42) is centered as well as relied on. The upper part is centered as well as connected with the lower part, with the use of two spigots (43, 44).

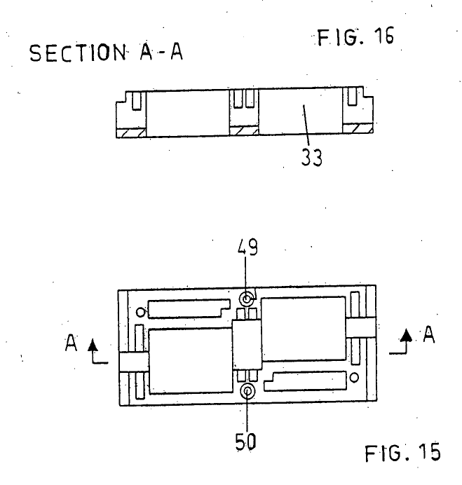

The lower part of the imprinting head (33), as depicted in FIGS. 15 and 16, has specially shaped perforations, in which the four sliding parts (45, 46, 47, 48) and the two rolling platens (21, 22), mounted on axle (26) that is in the shape of a geometrical zigzag, are placed. Also, the lower part has two perforations (49, 50), in which the two spigots (43, 44) are inserted. By assembling the imprinting head, two specially shaped perforations (51, 52) are created at its ends, as illustrated in FIG. 11. Theses are used in order to help the imprinting head slide along the base plate.

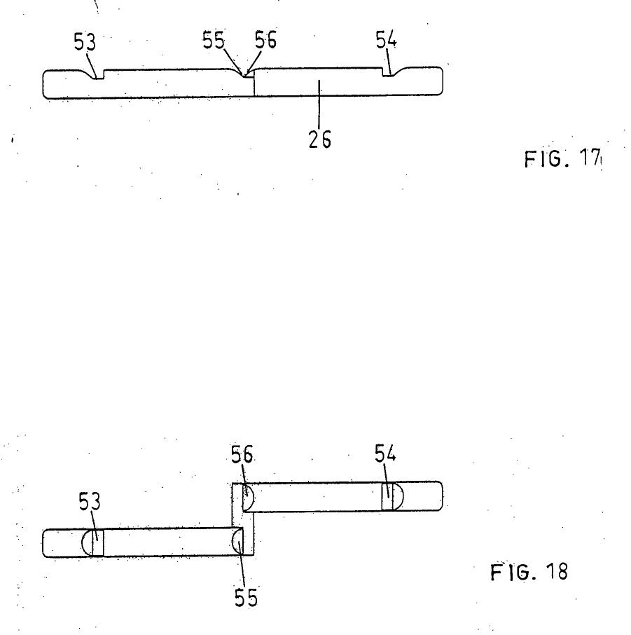

The axle (26), illustrated in FIGS. 17 and 18, used for the movement and the rotation of the rolling platens, has a special geometrical shape (zigzag) and four perforation (53, 54, 55, 56), two of which are located at the ends (53, 54) and two are located in its central part (55, 56). The perforations are not rectangular, but one of their sides makes a bent so that the sliding parts (45, 46, 47, 48) can slide up and down. The two rolling platens (21, 22) are placed among the axle's perforations.

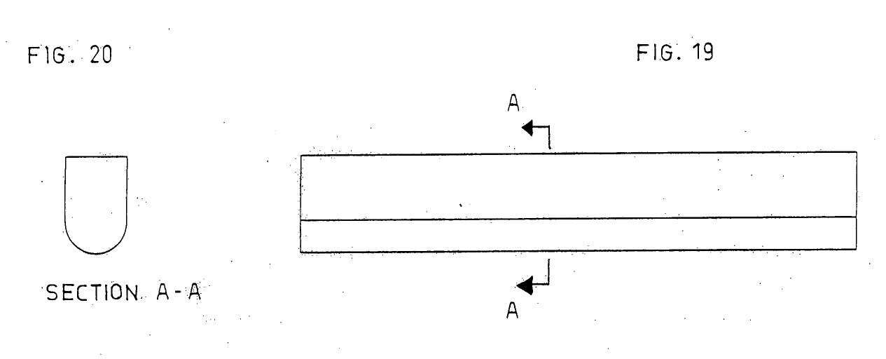

The four sliding parts (45, 46, 47, 48), illustrated in FIGS. 19 and 20, have an upper surface that is flat and a lower surface that is hemispherical.

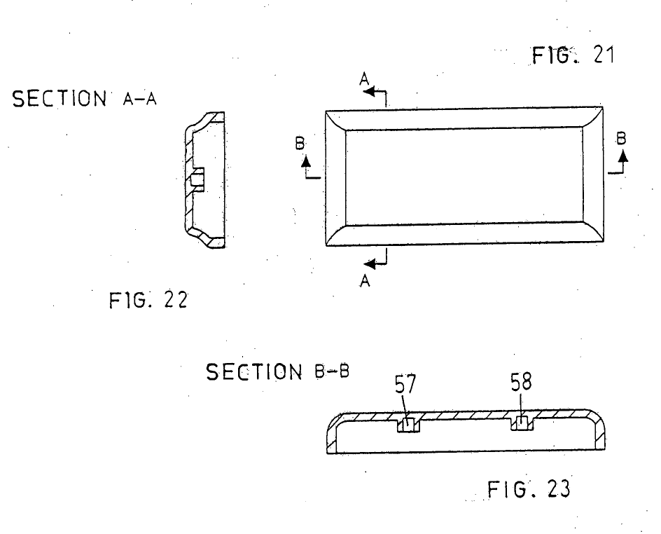

The cover (42) of the imprinting head (2), illustrated in FIGS. 21, 22 and 23, is used in order to cover the carriage and to write upon it personal information of the manufacturer or the customer. The cover has continuing edges (57, 58) in which the two spigots (40, 41) of the carriage's upper part (32) are inserted.

The aforementioned parts are firmly and unbreakably bound not only among each other but also with the base of the imprinter.

The imprinting quality of the specific device is so good that it could even replace the conventional stationary (immobile) devices that are manufactured today and found at almost all retail establishments.

While only a single suggested model of the invention has been described, it should be understood that in practice many variations might be made without thereto departing from the spirit of the invention, as defined in the appended claims. The present application aims at establishing all the variations that may accrue, within however the scope of the appended claims.

1. A portable credit card imprinting device for use in imprinting a formset with embossed data from a credit card and a merchant plate, with pressure applied, comprising: a one-piece small integral special shaped base plate (1), made of an extruded piece of aluminum; two plastic end walls (12, 13), adjusted at the two end side walls of the base plate, causing the rotation of the axle (26) on which two rolling platens are mounted; and an imprinting head (2), rigidly connected to the base (1) running in a back and forward motion within the edges (3, 4) and along the base's top surface (5, 6), consisted of two rolling platens (21, 22), which have the capability of rotating, based on a single and unique specially shaped axle (26) and adjusted with the aid of four screws (36, 37, 38, 39) and four sliding parts (45, 46, 47, 48).

2. A portable credit card imprinting device in accordance with claim 1 wherein: the base plate (1) is rectangular, made of only one integral piece of aluminum, having its two larger ends forced upwards in a U shape and bending (closing) slightly inwards, forming two grooves—edges (3, 4) along the length of the base's larger side walls and two flat surfaces (5, 6), upon which the imprinting head (2) slides in order to run over the base plate, during its reversible motion, in order to complete the imprinting procedure.

3. A portable credit card imprinting device in accordance with claim 1 wherein: the base plate (1) is made of only one integral special shaped piece of aluminum, having along its length and within certain distance from its side walls, a specially formed projection (9), used to stop and hold the card after its insertion and to lead the formset, during its insertion, to the right position over the card and the merchant plate.

4. A portable credit card imprinting device in accordance with claim 1 wherein: the base plate (1) is made of only one integral special shaped piece of aluminum, having along the length of its one side's internal edge (3), a specially formed groove, in which the binding screws (25, 31) of the device's two plastic end walls are inserted.

5. A portable credit card imprinting device in accordance with claim 1 wherein: the axle (26), upon which the two rolling platens are mounted, has a special geometrical shape (zigzag) with four perforations, two at the ends (53, 54) and two at the central part (55, 56) of the axle, which are not rectangular, but they have one of their sides making a bent to facilitate the sliding of the sliding parts (45, 46, 47, 48).

6. A portable credit card imprinting device in accordance with claim 1 wherein: the axle (26), upon which the two rolling platens are mounted, has the capability to change position along the length of the imprinting head (2), while pressured by the projections of the two plastic ends (24, 30), causing by this way the rotation of the rolling platens (21, 22) in means of slightly rising one of the platens and simultaneously slightly lowering the other.

7. A portable credit card imprinting device in accordance with claim 1 wherein: the two plastic end walls (12, 13), adjusted at the two internal grooves—edges of the base plate (1), have two specially formed projections (24, 30), extending inwards over the surface of the base plate; and the sides of the projections make a bent, upon which the axle (26), during the ending of the imprinting head's reciprocal motion, is pressured to change position towards the opposite direction, causing the rolling platens to change position respectively, that is causing the first rolling platen to rise slightly and the second rolling platen to lower, ready to imprint.

8. A portable credit card imprinting device in accordance with claim 1 wherein: the two plastic end walls (12, 13), adjusted at the two internal grooves—edges of the base plate (1), have two specially formed projections (23, 29), extending inwards over the surface of the base plate (1), used to connect, with the use of screws, the two plastic end walls (12, 13), to the base plate (1).

9. A portable credit card imprinting device in accordance with claim 1 wherein: the two plastic end walls (12, 13), adjusted at the two internal grooves—edges of the base plate (1), have four specially formed projections (59, 60, 61, 62), extending inwards under the surface of the base plate (1), used for the adjustment of four round rubber bases to avoid the sliding of the credit card imprinting device.

10. A portable credit card imprinting device in accordance with claim 1 wherein: the four plastic sliding parts (45, 46, 47, 48), have their upper surface flat and their lower surface in a hemispherical shape; and they are placed between the screws (36, 37, 38, 39), used to adjust the distance between the rolling platens and the base plate, and the axle's (26) specially formed slots (53, 54, 55, 56), in order to protect the axle from being damaged.
